(19) United States
(12) Patent Application Publication
(10) Pub. No.: US 2018/0325344 A1
(43) Pub. Date: Nov. 15, 2018

(54) HIGH ABSORBENCY MOPS AND ASSOCIATED METHODS AND KITS

(71) Applicant: Rubbermaid Commercial Products LLC, Atlanta, GA (US)

(72) Inventor: Weidong Wu, Charlotte, NC (US)

(21) Appl. No.: 15/980,614

(22) Filed: May 15, 2018

Related U.S. Application Data
(60) Provisional application No. 62/506,423, filed on May 15, 2017.

(51) Int. Cl. A47L 13/255; A47L 13/46; B32B 21/08; B32B 27/08; B32B 27/32; B32B 27/30; B32B 27/36; B32B 37/06

(52) U.S. Cl. CPC A47L 13/255; B32B 2432/00; B32B 21/08; B32B 27/08; B32B 27/32; B32B 27/308; B32B 27/36; B32B 37/06; B32B 2250/03; B32B 2250/24; B32B 2307/728; B32B 2323/10; B32B 2323/04; B32B 2333/08; A47L 13/46

(57) ABSTRACT

High absorbency mops and associated methods and kits are provided. The mop includes a mob body with at least one outer layer and an inner layer. The outer layer of the mop contains a nonwoven material, and the inner layer contains sodium polyacrylate in an amount of at least one percent by weight of the inner layer.

### CROSS REFERENCE TO RELATED APPLICATIONS

This application claims priority benefit of U.S. Provisional Patent Application No. 62/506,423, filed May 15, 2017, which is incorporated by reference herein in its entirety.

### TECHNICAL FIELD

The present application generally relates to mops, and, more specifically, relates to high absorbency mops.

### BACKGROUND

Manual mopping devices and similar spill cleaning tools are known, such as string mops, flat mops, towels, cloths, napkins, paper towels, and granular absorbents. However, for liquid spills, such tools are known to drip after absorption of the liquid, provide limited absorbency, and/or require the user to handle the absorbed cleaning material. Such tools, when reusable, may result in cross-contamination of liquid absorbed between different tasks.

### SUMMARY

In one aspect, a mopping device is provided, including a disposable mop including a mop body having at least one outer layer and an inner layer, in which the outer layer is made of a nonwoven material and the inner layer is made of sodium polyacrylate in an amount of at least one percent by weight of the inner layer.

In another aspect, a kit is provided, including at least one disposable mop having a mop body that has at least one outer layer and an inner layer, the outer layer containing a nonwoven material and the inner layer containing sodium polyacrylate in an amount of at least about one percent by weight of the inner layer. The kit also includes a handle having a collapsible elongated pole and means for securing the disposable mop at an end of the collapsible elongated pole.

In another aspect, a method of manufacturing a disposable mop is provided, and includes forming an inner layer having sodium polyacrylate in an amount of at least about one percent by weight of the inner layer, forming at least one outer layer having a nonwoven material, and then coupling the inner and outer layers to form a mop body.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a top view of one embodiment of a mop body of a mopping device, in accordance with the present disclosure.

FIG. 2 is a perspective view of one embodiment of a handle of the mopping device, in accordance with the present disclosure.

FIG. 3A is a magnified, partial perspective view of one embodiment of a locking hole on a collapsible elongated pole and a locking mechanism of the mopping device, in accordance with the present disclosure.

FIG. 3B is a magnified, partial perspective view of one embodiment of a collapsible elongated pole, locking mechanisms, and a clamp of the mopping device, in accordance with the present disclosure.

FIG. 3C is a magnified, partial perspective view of one embodiment of locking mechanisms of the mopping device, in accordance with the present disclosure.

FIG. 4 is an exploded, cross-sectional view of the mop body in FIG. 1, in accordance with the present disclosure.

FIG. 5 is a perspective view of a kit of the mopping device, in accordance with the present disclosure.

### DETAILED DESCRIPTION

Embodiments of the present disclosure provide a mopping device, along with associated methods and kits, which is configured to provide increased absorbency of liquid in a disposable mop format, so that cross-contamination of liquids absorbed by the mopping device can be avoided. In example embodiments, the mopping devices has a mop body configured to attach to a suitable handle or pole.

Mopping Devices

In certain embodiments, as illustrated in the various figures, a mopping device includes a disposable mop 102 and a handle 112 designed to engage the disposable mop 102 for manipulating and maneuvering the disposable mop 102 across a floor or other surface. In some embodiments, the disposable mop 102 may be used to clean a surface without the use of the handle 112, by a user holding a portion of the disposable mop 102 directly.

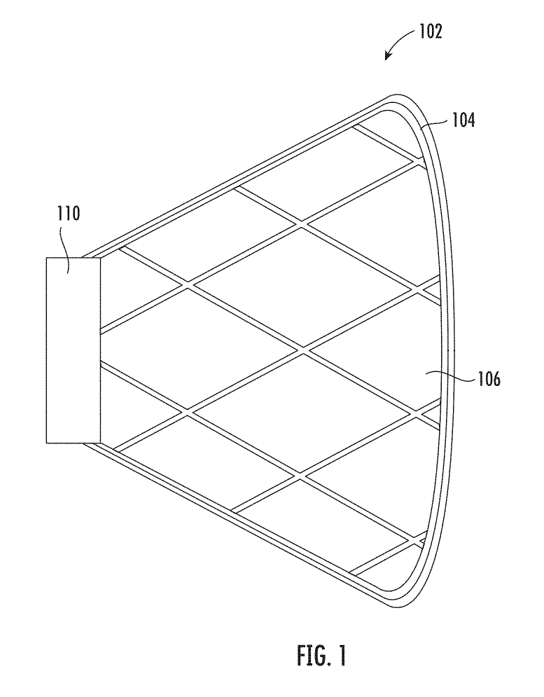

In some embodiments, as shown in FIGS. 1 and 4, the disposable mop 102 includes a mop body 104 formed of at least one outer layer 106 and an inner layer 108. In one embodiment, the mop body 104 is formed of two outer layers 106 sandwiching the inner layer 108, although it should be understood that the mop body may be composed of any combination of various outer and inner layers, such as are described herein, including a plurality of inner layers within the mop body.

As will be discussed in greater detail below, the outer layer 106 may be formed of a suitable nonwoven material and the inner layer 108 may be formed of a suitable superabsorbent material.

In some embodiments, the outer layer 106 is a nonwoven having hydrophilic properties. For example, the nonwoven may be formed from polypropylene, polyethylene, polyester, cotton, nylon, rayon, or a combination thereof. In one embodiment, the nonwoven material of the outer layer 106 of the mop body 104 is formed of a spunbonded, spunlaced, needle punched, chemically bonded, or other nonwoven material made of one or more of polypropylene, polyethylene, polyester, cotton, nylon, or rayon. In some embodiments, the nonwoven material of the outer layer 106 of the mop body 104 is formed of a spunbonded mixture of polypropylene and polyethylene. For example, the spunbonded nonwoven may contain polypropylene in an amount of about 40 percent to about 90 percent, by weight of the outer layer 106, with the remainder of the nonwoven being polyethylene. In some embodiments, the spunbonded nonwoven contains polypropylene in an amount of about 50 percent, by weight of the outer layer 106, with the remainder of the nonwoven being polyethylene. In some embodiments, the spunbonded nonwoven contains polypropylene in an amount of about 70 percent to about 80 percent, by weight of the outer layer 106, with the remainder of the nonwoven being polyethylene. In one embodiment, the spunbonded nonwoven contains polypropylene in an amount of about 75 percent by weight of the outer layer 106, with the remainder of the nonwoven being polyethylene. Having a hydrophilic material forming the outer surface of the mop body 104 that comes into contact with a spill or other liquid to be absorbed allows that mop body 104 to absorb the liquid immediately upon contact.

In some embodiments, the inner layer 108 contains a suitable superabsorbent material, such as a superabsorbent polymer (SAP), such as sodium polyacrylate, in an amount of at least about 1 percent, by weight of the inner layer 108. For example, the inner layer 108 of the mop body 104 may contain the SAP in an amount of about 10 percent to about 100 percent, by weight of the inner layer 108, such as from about 20 percent to about 100 percent, by weight of the inner layer 108, or from about 30 percent to about 100 percent, by weight of the inner layer 108. In certain embodiments, the inner layer 108 of the mop body 104 contains the SAP in an amount of at least about 10 percent, by weight of the inner layer 108, such as from about 10 percent to about 99 percent, by weight of the inner layer 108. In some embodiments, the inner layer 108 of the mop body 104 contains the SAP in an amount of from about 30 percent to about 99 percent, by weight of the inner layer 108. In one embodiment, the inner layer 108 of the mop body 104 contains the SAP in an amount of at least about 50 percent, by weight of the inner layer 108. For example, in one embodiment, the inner layer 108 of the mop body 104 contains the SAP in an amount of 60 percent, by weight of the inner layer 108.

In some embodiments, the inner layer 108 also contains a suitable volumizing material, such as a lightweight batting-type material. For example, the volumizing material may be a polyester (e.g., polyethylene terephthalate) and/or a polypropylene material configured to provide volume within the inner layer 108 to accommodate swelling of the SAP after absorption of the liquid. For example, the inner layer 108 may contain the volumizing material in an amount of from about 5 percent to about 40 percent, by weight of the inner layer 108, such as about 25 percent to about 35 percent, or about 5 percent to about 15 percent, by weight of the inner layer 108. In some embodiments, the inner layer 108 further contains a wood pulp material. For example, the wood pulp material may be present in an amount of about 5 percent to about 20 percent, by weight of the inner layer 108, such as from about 8 percent to about 13 percent, or about 12 to about 20 percent, by weight of the inner layer 108.

In some embodiments, the inner layer 108 is present in an amount of at least 60 percent, by weight, of the total mop body 104. For example, the inner layer 108 may be present in an amount from about 70 percent to about 90 percent, by weight of the total mop body 104.

In certain embodiments, as shown in FIG. 1, the disposable mop 102 also includes a headband 110 coupled to the mop body 104. For example, the headband 110 may be any suitable material and configuration known in the art, such as a spunbonded nonwoven polypropylene material. In some embodiments, the disposable mop 102 (e.g., the mop body 104 and, optionally, the headband 110) is substantially planar. In some embodiments, the disposable mop 102 has a suitable shape, such as a rectangular, wedge, modified wedge (as shown in FIG. 1), circular, elliptical, semicircular, or an irregular shape.

In certain embodiments, the disposable mop 102 is capable of absorbing liquid in an amount of at least 12 times its weight, such as at least 15 times its weight. Such absorbency is heretofore unknown in string and microfiber mops. In some embodiments, the disposable mop 102 is capable of absorbing about 32 ounces of liquid, such as water. Further, in certain embodiments, the disposable mop 102 is capable of absorbing about 32 ounces of water without dripping. For example, the mop may be capable of absorbing from about 32 fluid ounces to about 100 fluid ounces of liquid. For example, dripping may be avoided through the use of an SAP that transforms into a gel upon exposure to liquid, effectively trapping the liquid in the inner layer 108 of the mop body 104.

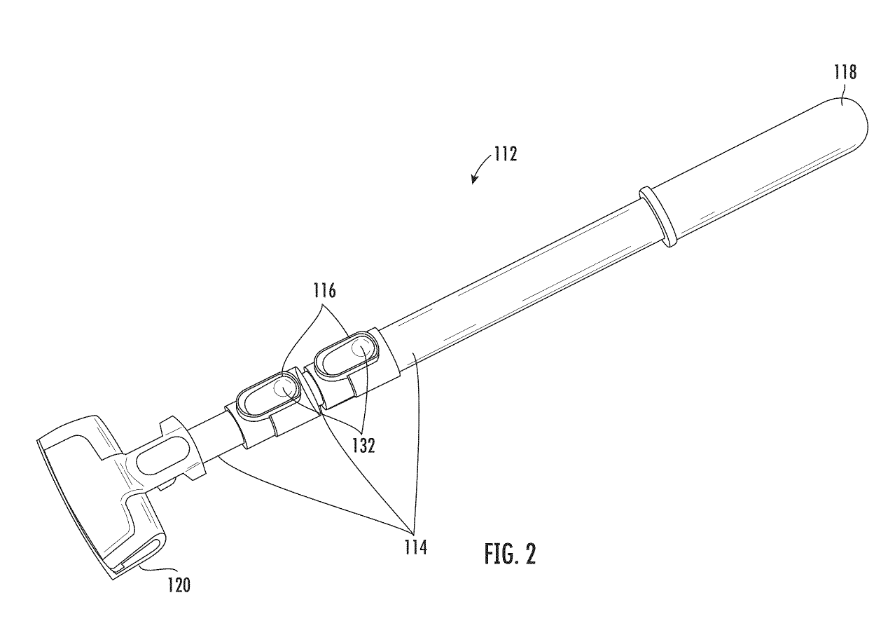

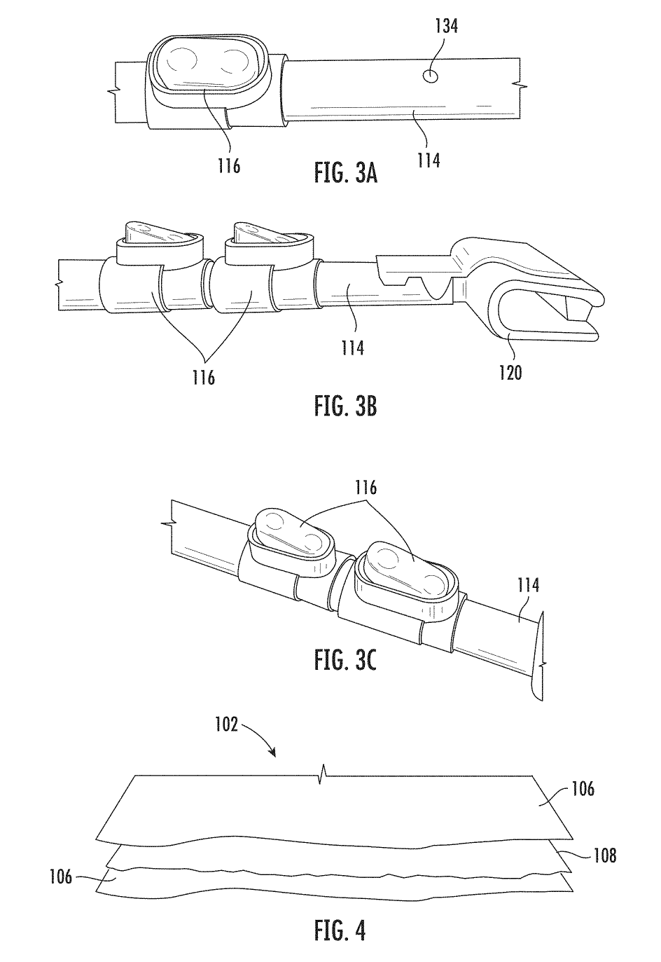

In certain embodiments, as shown in FIGS. 2, 3, and 5, in addition to the disposable mop, a mopping device further includes a handle 112 that includes a collapsible elongated pole 114 and means for securing the disposable mop 102 at an end of the collapsible elongated pole 114. For example, as shown in FIGS. 2 and 3, the collapsible elongated pole 114 may be a telescoping sectioned tube with one or more locking mechanisms 116 that allow a user to elongate the tube to the desired length and secure the tube in the extended configuration. For example, the extended pole 114 may have an extended length of from about 40 to about 70 inches, such as from about 40 to about 50 inches, with two or more telescoping sections. For example, the extended pole 114 may be about 47.5 inches in length with three telescoping sections.

In certain embodiments, the handle 112 includes a grip portion 118 at an end opposite the means for securing the disposable mop. For example, the grip portion 118, or another suitable portion of the handle 112 (e.g., a portion of the pole 114 at or near the securing means), may include user-actuatable means (e.g., a button, lever, etc.) (not shown) in operable connection with the means securing the disposable mop 102 at the end of the collapsible elongated pole 114, such that the disposable mop 102 secured at the end of the collapsible elongated pole 114 is releasable via actuation of the user-actuatable means. Thus, in comparison to other spill pads, the present mopping device has a handle 112 that allows a user to release the absorbed mop, so that the user does not have to touch the absorbed mop. Moreover, the user does not have to bend down to move the mop, like with a napkin or towel because of the handle 112. Further, because the disposable mops are designed for one-time or single use, they can prevent cross contamination and make liquid spills clean up relatively easier.

In certain embodiments, the means for securing the disposable mop 102 at an end of the collapsible elongated pole 114 may be any suitable means known in the art, such as a clamp 120 or other suitable mechanical connector that may be configured to release a secured pad from the connector upon input from the user-actuatable means. In some embodiments, the means for securing the disposable mop 102 is itself secured at an end of the collapsible elongated pole 114, such as through a threaded or other suitable mechanical connection. For example, the elongated pole 114 may have a crimped connection securing the gripper head, such that a suitable securing means for the mop may be selectively attached to the gripper head at the end of the elongated pole 114.

Kits

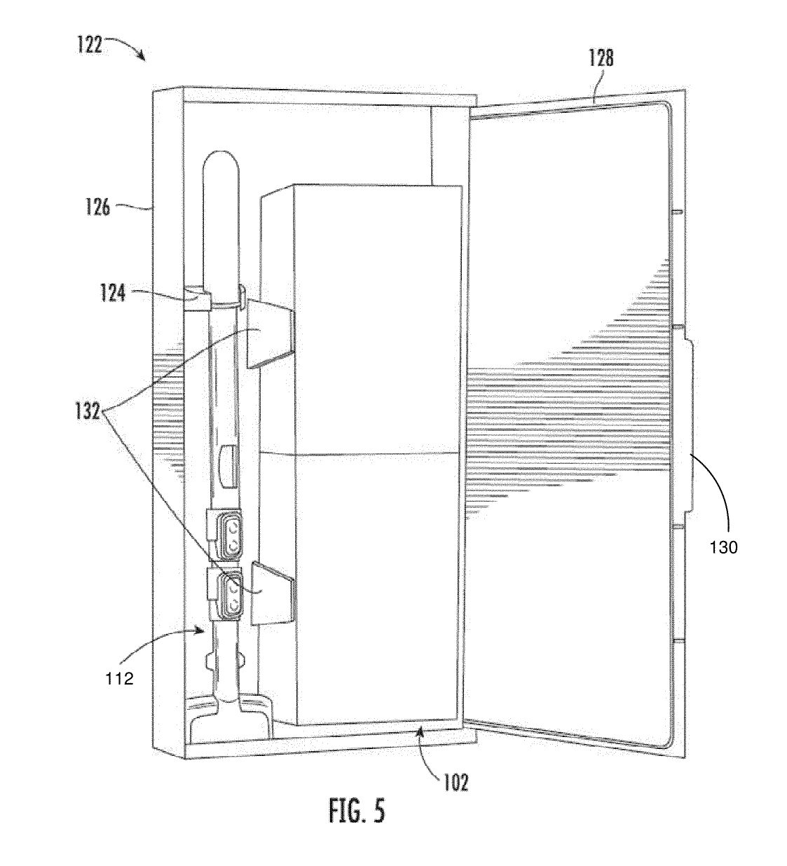

In certain embodiments, as shown in FIG. 5, a kit 122 for cleaning a spill or other liquid is provided. For example, the kit 122 may include at least one disposable mop 102 (shown contained in a pack of mops packaged within a box) as described below, and a handle 112 having a collapsible elongated pole 114 and means for securing the disposable mop 102 at an end of the collapsible elongated pole 114. For example, as shown in FIG. 5, the kit 122 may contain one or more of the disposable mops.

In certain embodiments, the kit 122 includes at least two distinct types of disposable mops, such as one for general purpose spills (e.g., water-based spills) and one for biohazardous spills (e.g., spills containing bodily fluids or hazardous chemicals). For example, as discussed below with reference to the examples, the general purpose mop body 104 and the biohazardous mop body 104 may have different inner layer 108 compositions.

In certain embodiments, the kit 122 includes a wall mountable or other storage container for housing the collapsed pole 114 and the mops. For example, the kit 122 may include a cabinet 126 having a hinged door 128, an integrated latch structure 130, brackets 132 for mounting the mops or cartridges containing one or more mops, and means 124 for hanging or mounting the handle 112.

Methods

In certain embodiments, methods of manufacturing a disposable mop 102 include forming an inner layer 108, as described below, such as by any suitable means known in the art. For example, the inner layer 108 may be an airlaid SAP combined with the volumizing material and any other materials (e.g., wood pulp) to form the inner layer 108 composite material. Further, the outer layer 106, as described herein, may be formed by any suitable means known in the art. For example, any suitable nonwoven manufacturing processes may be used. In one embodiment, the nonwoven material is formed in a spunbond, spunlace, needle punch, or chemical bonding process.

Next, the inner and outer layers 108, 106 may be cut to the desired shape and bonded together. Any suitable coupling methods known in the art may be used. For example, adhesive bonding, heat sealing, or welding techniques, such as ultrasonic welding may be used to bond the inner and outer layers 108, 106 around their edges, to form the mop body 104.

In certain embodiments a headband 110 material, as described herein, may be provided and sized to the desired width and length. The headband 110 may be associated with the mop body 104 by any suitable methods known in the art. For example, adhesive bonding, heat sealing, or welding techniques, such as ultrasonic welding may be used to bond the headband 110 to the mop body 104.

The embodiments in this disclosure can be further understood and illustrated by the following non-limiting examples.

### EXAMPLES

Disposable mop prototypes were manufactured according to the specifications described above with respect to the mop embodiment 102 illustrated in FIGS. 1 and 4 and were tested in lab for liquid absorption. The mops demonstrated the capability of absorbing at least 32 ounces of water, 32 ounces of cola, 20 ounces of coffee, 16 ounces of beer, 5 ounces of wine, and 16 ounces of saline solution (NaCl 0.85% w/w). No drips were observed after the mop completely absorbed the liquids and saturated.

Thus, it was discovered that a highly absorbent mop could be achieved through the devices, methods, and kits described herein.

It will be apparent to those skilled in the art that various modifications and variations can be made to the present disclosure without departing from the scope of embodiments of the disclosure. Thus, it is intended that the described embodiments cover the modifications and variations of the disclosure provided they come within the scope of the appended claims and their equivalents.

What is claimed is:

1. A mopping device, comprising:
a disposable mop comprising a mop body that comprises at least one outer layer and an inner layer, the at least one outer layer comprising a nonwoven material and the inner layer comprising sodium polyacrylate in an amount of at least about 1 percent, by weight of the inner layer.

2. The mopping device of claim 1, wherein the nonwoven material of the at least one outer layer of the mop body is selected from polypropylene, polyethylene, and combinations thereof.

3. The mopping device of claim 1, wherein the nonwoven material of the at least one outer layer of the mop body comprises a spunbonded nonwoven comprising a mixture of polypropylene and polyethylene.

4. The mopping device of claim 1, wherein the inner layer of the mop body comprises sodium polyacrylate in an amount of about 10 percent to about 99 percent, by weight of the inner layer.

5. The mopping device of claim 1, wherein the inner layer of the mop body further comprises polyester, wood pulp, or both.

6. The mopping device of claim 1, wherein:
the disposable mop is substantially planar, and
the mop body comprises two of the at least one outer layers sandwiching the inner layer.

7. The mopping device of claim 1, wherein the disposable mop is capable of absorbing at least 12 times its weight in liquid.

8. The mopping device of claim 1, wherein the disposable mop is capable of absorbing at least 32 fluid ounces of liquid.

9. The mopping device of claim 1, further comprising a handle having
a collapsible elongated pole; and
means for securing the disposable mop at an end of the collapsible elongated pole.

10. The mopping device of claim 9, wherein the handle further comprises user-actuatable means in operable connection with the means securing the disposable mop at the end of the collapsible elongated pole, such that the disposable mop secured at the end of the collapsible elongated pole is releasable via actuation of the user-actuatable means.

11. A kit, comprising:
at least one disposable mop comprising a mop body that comprises at least one outer layer and an inner layer, the at least one outer layer comprising a nonwoven material and the inner layer comprising sodium polyacrylate in an amount of at least about 1 percent, by weight of the inner layer; and
a handle comprising a collapsible elongated pole and means for securing the disposable mop at an end of the collapsible elongated pole.

12. The kit of claim 11, wherein the handle further comprises user-actuatable means in operable connection with a means for securing the disposable mop at the end of the collapsible elongated pole, such that the disposable mop secured at the end of the collapsible elongated pole is releasable via actuation of the user-actuatable means.

13. A method of manufacturing a disposable mop, comprising:
forming an inner layer comprising sodium polyacrylate in an amount of at least about 1 percent, by weight of the inner layer;
forming at least one outer layer comprising a nonwoven material; and
coupling the inner layer and at least one outer layer to form a mop body.

14. The method of claim 13, wherein the nonwoven material of the at least one outer layer comprises polypropylene, polyethylene, or both.

15. The method of claim 13, wherein the inner layer comprises sodium polyacrylate in an amount of about 10 percent to about 99 percent, by weight of the inner layer.

16. The method of claim 13, wherein coupling the inner layer and the at least one outer layer comprises heat sealing or ultrasonic welding.

17. The method of claim 13, further comprising coupling a headband to the mop body.

18. The method of claim 13, wherein
the disposable mop is substantially planar, and
the mop body comprises two of the at least one outer layer sandwiching the inner layer.

19. The method of claim 13, wherein the disposable mop is capable of absorbing at least 12 times its weight in liquid.

20. The method of claim 13, wherein the disposable mop is capable of absorbing at least 32 fluid ounces of liquid.
